(19) United States
(12) Patent Application Publication
(10) Pub. No.: US 2023/0418664 A1
(43) Pub. Date: Dec. 28, 2023

(54) ADAPTIVE THREAD MANAGEMENT FOR HETEROGENOUS COMPUTING ARCHITECTURES

(71) Applicants: Advanced Micro Devices, Inc., Santa Clara, CA (US); ATI Technologies ULC, Markham (CA)

(72) Inventors: Donny Yi, Austin, TX (US); Indrani Paul, Austin, TX (US); Ashwini Chandrashekhara Holla, Markham (CA)

(21) Appl. No.: 17/846,593

(22) Filed: Jun. 22, 2022

(51) Int. Cl. G06F 9/48; G06F 9/38; G06F 9/50; G06F 9/30

(52) U.S. Cl. CPC G06F 9/4881; G06F 9/3836; G06F 9/5038; G06F 9/5044; G06F 9/30079

(57) ABSTRACT

An apparatus and method for efficiently scheduling tasks in a dynamic manner to multiple cores that support a heterogeneous computing architecture. A computing system includes multiple cores with at least two cores being capable of executing instructions of a same instruction set architecture (ISA), and therefore, are architecturally compatible. In an implementation, each of the at least two cores is a general-purpose central processing unit (CPU) core capable of executing instructions of a same ISA. However, the throughput and the power consumption greatly differ between the at least two cores based on their hardware designs. An operating system scheduler assigns a thread to a first core, and the first core measures thread dynamic behavior of the thread over a time interval. Based on the thread dynamic behavior, the scheduler reassigns the thread to a second core different from the first core.

### BACKGROUND

### Description of the Relevant Art

In some designs, the microarchitecture of each of a first core and a second core is capable of executing a particular type of task. For example, each of the first core and the second core is capable of executing instructions of a same instruction set architecture (ISA), and therefore, are architecturally compatible. The first core and the second core have permissible access to the same regions of memory, and therefore, it is possible to swap workloads between them. However, the hardware design of the first core emphasizes high performance (high throughput), which also increases power consumption. In contrast, the hardware design of the second core emphasizes low power consumption.

The first core can use a general-purpose microarchitecture and include hardware that emphasizes high performance, rather than low power consumption. In contrast, the second core includes hardware that emphasizes low power consumption, rather than high performance. For example, the first core utilizes hardware of standard cells from cell libraries that focus on high performance (high throughput) such as using transistors with shorter channel lengths, higher doping concentrations of the source regions and drain regions, thinner gate oxide thicknesses, and so forth. In contrast, the second core utilizes hardware of standard cells from cell libraries that focus on low power consumption such as using transistors with longer channel lengths, lower doping concentrations of the source regions and drain regions, larger gate oxide thicknesses, and so forth. It is also possible that in some designs the first core uses more hardware than the second core to support multiple-instruction issue, dispatch, execution, and retirement; extra routing and logic to determine data forwarding for multiple instructions simultaneously per clock cycle; intricate branch prediction schemes, support of deep pipelines, support of simultaneous multi-threading; access relatively large caches, and other design features. In contrast, the second core uses the same general-purpose microarchitecture, but includes significantly less of the listed hardware of the first core. When an architecture includes at least two cores that are architecturally compatible, but the throughput and the power consumption greatly differ between them, the architecture is referred to as a “heterogeneous computing architecture” or a “heterogeneous processing architecture.”

The above labeling of the architecture is not to be confused with a “heterogeneous architecture” that includes at least two cores that are not architecturally compatible such that the at least two cores use different microarchitectures such as a general-purpose microarchitecture and a relatively wide single instruction multiple data (SIMD) microarchitecture. To schedule workloads running on a computer system with a heterogeneous computing architecture, an operating system (OS) scheduler uses a round-robin scheme or a scheme based on availability of the cores. However, these scheduling schemes restrict performance or consume an appreciable amount of power when there is a mismatch between the scheduling schemes and the system resources.

In view of the above, efficient methods and mechanisms for efficient dynamic scheduling of tasks to multiple cores are desired.

### BRIEF DESCRIPTION OF THE DRAWINGS

FIG. 1 is a generalized block diagram of a computing system that efficiently schedules threads on cores that support a heterogeneous computing architecture.

FIG. 2 is another generalized block diagram of a computing system that efficiently schedules threads on cores that support a heterogeneous computing architecture.

FIG. 3 is a generalized block diagram of thread assignments for a computing system that uses cores that support a heterogeneous computing architecture.

FIG. 4 is a generalized block diagram of a method for assigning threads in a computing system that uses cores that support a heterogeneous computing architecture.

FIG. 5 is a generalized block diagram of a method for updating information used in assigning threads in a computing system that uses cores that support a heterogeneous computing architecture.

FIG. 6 is a generalized block diagram of a method for assigning threads in a computing system that uses cores that support a heterogeneous computing architecture.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently scheduling tasks in a dynamic manner to multiple cores that support a heterogeneous computing architecture are contemplated. In various implementations, a computing system includes multiple processor cores (or multiple cores) that support a heterogeneous computing architecture. At least two cores of the multiple cores are capable of executing instructions of a same instruction set architecture (ISA), and therefore, are architecturally compatible. The at least two cores have permissible access to the same regions of memory, and therefore, it is possible to swap workloads between them. However, the hardware design of one of the at least two cores emphasizes high performance (high throughput), which also increases power consumption. In contrast, the hardware design of the other core of the at least two cores emphasizes low power consumption. In an implementation, each of the at least two cores is a general-purpose central processing unit (CPU) core capable of executing instructions of a same instruction set architecture (ISA).

When an architecture includes at least two cores that are architecturally compatible, but the throughput and the power consumption greatly differ between them, the architecture is referred to as a “heterogeneous computing architecture” or a “heterogeneous processing architecture.” Such a type of architecture is not to be confused with a “heterogeneous architecture” that includes at least two cores that are not architecturally compatible such that at least two cores use different microarchitectures. An example of a heterogeneous architecture is a computing system that has a first core, such as a CPU core, that includes a general-purpose microarchitecture, and a second core, such as a graphics processing unit (GPU) core, that includes a relatively wide single instruction multiple data (SIMD) microarchitecture. It is noted that a computing system can simultaneously include a heterogeneous computing architecture (or a heterogeneous processing architecture) and a heterogeneous architecture. For example, in an implementation, the computing system includes at least two CPU cores that are architecturally compatible, but the throughput and the power consumption greatly differ between them. This computing system also includes at least a GPU core or other core that uses a wide SIMD microarchitecture.

A computing system uses at least a multi-core heterogeneous computing architecture. Hardware, such as circuitry, of a particular core of the multiple cores of the computing system executes instructions of an operating system scheduler. This particular core can be a general-purpose CPU core. It is noted that over time one or more cores execute instructions of the operating system scheduler. For example, the hardware of one or more cores, such as CPU cores, separately execute instructions of the kernel at different points in time, and access certain one or more regions of shared memory. One of the shared data structures maintained by the one or more cores executing the operating system kernel is a list of threads that are ready to run. Therefore, it is possible and contemplated that at a later point in time, hardware of a core different from the particular core executes instructions of the operating system scheduler. As used herein, the terms “scheduler” and “scheduling core” refer to one or both of software and hardware executing to schedule threads for execution. In some implementations, a core acting as a scheduler, or otherwise executing scheduling software, is referred to as a scheduling core. For example, a core of multiple cores may be executing instructions of an operating system scheduler. The scheduler assigns a thread to a first core of the multiple cores of the computing system. The first core can be any one of the multiple cores of the computing system. The scheduler assigns the thread to the first core based on availability of the multiple cores, a round-robin scheduling scheme, or another initial scheduling scheme. The first core determines a classification of the thread based on hardware performance metrics measured over a time interval. In various implementations, the first core includes hardware performance counters that monitor hardware events that occur in the first core while the first core executes the assigned thread. In some implementations, the first core includes one or more multi-bit registers that are used as hardware performance counters capable of counting multiple hardware-related activities.

The first core compares the values stored in one or more of the hardware performance counters to thresholds to determine the dynamic behavior of the assigned thread. The number of events that at least reach predetermined thresholds are used to determine the classification of the assigned thread. Examples of the classification are a non-scalable thread, an input/output (I/O) or memory bound thread, a vector thread, or other. The first core communicates the classification, which is an indication of thread dynamic behavior of the thread, with the scheduler. As described earlier, the scheduler is the core of the multiple cores that at the current point in time executes instructions of the operating system scheduler. In order to communicate, in some implementations, the first core writes a particular value (or values) in a predetermined configuration register such as a machine-specific register (MSR) assigned to the first core. The scheduler checks, inspects, or polls this predetermined configuration register to determine the value stored in the predetermined configuration register. Based on the stored value that was written earlier by the first core, the scheduler determines the classification, which is the indication of dynamic behavior of the thread as determined by the first core. The scheduler reassigns the thread to a second core different from the first core based at least in part on the indication of dynamic behavior of the thread.

In an implementation, the classification of the above thread indicates that the thread is part of a process that runs background tasks. However, the scheduler originally assigned the thread to a first core that is a high-performance CPU core based on availability, a round-robin scheme, or other. The first core uses the hardware performance counters to classify the thread as a non-scalable thread or other type of thread that is preferably assigned to a low-power core. The first core communicates the classification to the scheduling core (core running the OS scheduler), and the scheduling core removes this thread from the high-performance core and reassigns this thread to a low-power core. It is noted that as used herein, a “high-performance” core refers to a core designed to operate at a higher performance and/or power level than the “low-power” core. Further details of efficiently scheduling tasks in a dynamic manner to multiple cores that support a heterogeneous computing architecture are provided in the below discussion.

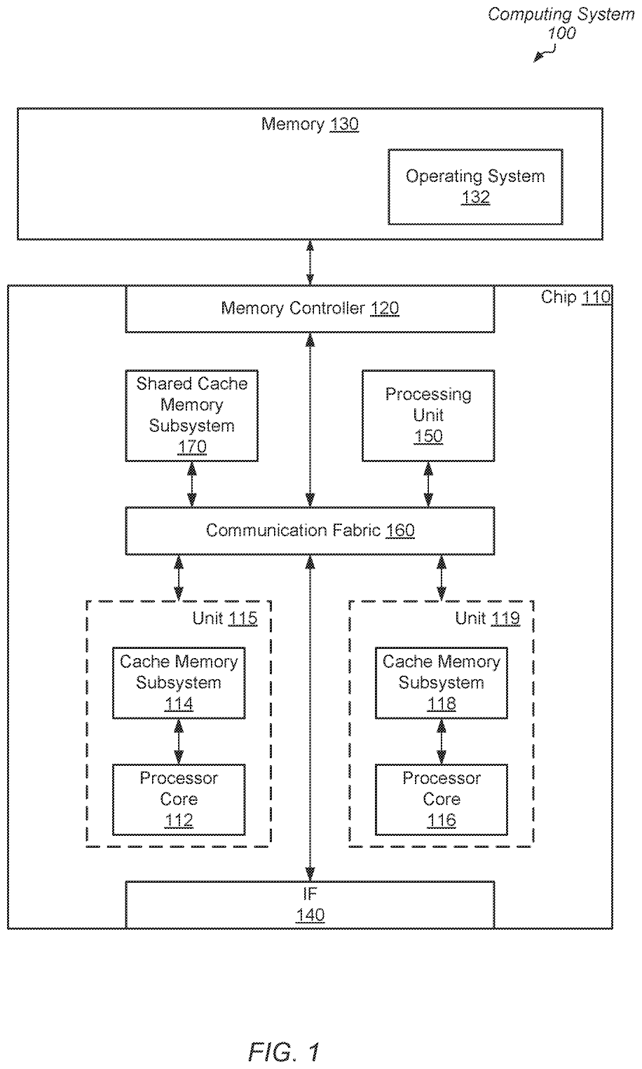

Referring to FIG. 1, a generalized block diagram is shown of a computing system 100 that efficiently schedules threads on cores that support a heterogeneous computing architecture. The computing system 100 includes the semiconductor chip 110 and the memory 130. The semiconductor chip 110 (or chip 110) includes multiple types of integrated circuits. For example, the chip 110 includes at least multiple processor cores (or cores) such as cores within the processing unit 150 and cores 112 and 116 of processing units (units) 115 and 119. A variety of choices exist for placing the circuitry of chip 110 in system packaging to integrate the multiple types of integrated circuits. Some examples are a system-on-a-chip (SOC), multi-chip modules (MCMs), and a system-in-package (SiP). Clock sources, such as phase lock loops (PLLs), interrupt controllers, power controllers, interfaces for input/output (I/O) devices, and so forth are not shown in FIG. 1 for ease of illustration.

The chip 110 includes the memory controller 120 to communicate with the memory 130, interface logic 140, the processing units (units) 115 and 119, communication fabric 160, a shared cache memory subsystem 170, and a shared processing unit 150. The processing unit 115 includes the core 112 and corresponding cache memory subsystems 114. The processing unit 119 includes the core 116 and corresponding cache memory subsystem 118. Memory 130 is shown to include operating system code 132. It is noted that various portions of operating system code 132 can be resident in memory 130, in one or more caches (114, 118), stored on a non-volatile storage device such as a hard disk (not shown), and so on. In an implementation, the illustrated functionality of chip 110 is incorporated upon a single integrated circuit.

Although two units 115 and 119, each with a single core (core 112 and core 116, respectively), are shown, it is possible and contemplated that the chip 110 includes another number of units, each with another number of cores, based on design requirements. Similarly, although a single processing unit 150 is shown, in other implementations, the chip includes another number of other processing units capable of communication with other components of the chip 110 via the communication fabric 160. In various implementations, the cores 112 and 116 are capable of executing one or more threads and share at least the shared cache memory subsystem 170, the processing unit 150, and coupled input/output (I/O) devices connected to the interface (IF) 140.

In various implementations, the two cores 112 and 116 are capable of executing instructions of a same instruction set architecture (ISA), and therefore, are architecturally compatible. The two cores 112 and 116 have permissible access to the same regions of memory, and therefore, it is possible to swap workloads between them. In an implementation, each of two cores 112 and 116 is a general-purpose central processing unit (CPU) core capable of executing instructions of a same ISA. However, in an implementation, the hardware design of the core 112 emphasizes high performance (high throughput), which also increases power consumption. In contrast, the hardware design of the core 116 emphasizes low power consumption. In some implementations, the high-performance core 112 utilizes hardware of standard cells from cell libraries that focus on high performance (high throughput) such as using transistors with shorter channel lengths, higher doping concentrations of the source regions and drain regions, thinner gate oxide thicknesses, and so forth. In contrast, the low-power core 116 utilizes hardware of standard cells from cell libraries that focus on low power consumption such as using transistors with longer channel lengths, lower doping concentrations of the source regions and drain regions, larger gate oxide thicknesses, and so forth. It is also possible and contemplated that the high-performance core 112 includes hardware, such as circuitry, for multiple-instruction issue, dispatch, execution, and retirement; extra routing and logic to determine data forwarding for multiple instructions simultaneously per clock cycle; intricate branch prediction schemes, support of deep pipelines, support of simultaneous multi-threading; access relatively large caches, and other design features.

It is possible and contemplated that in contrast to the high-performance core 112, the low-power core 116 includes significantly less of the above list of hardware of the high-performance core 112. Accordingly, the low-power core 116 consumes appreciably less power, but also has a far lower throughput than the high-performance core 112. When an architecture includes at least two cores that are architecturally compatible, but the throughput and the power consumption greatly differ between them, the architecture is referred to as a “heterogeneous computing architecture” or a “heterogeneous processing architecture.” Such a type of architecture is not to be confused with a “heterogeneous architecture” that includes at least two cores that are not architecturally compatible such that at least two cores use different microarchitectures. An example of a heterogeneous architecture is a computing system that has a first core, such as the high-performance CPU core 112, and a second core, such as a core of the processing unit 150. In an implementation, the one or more cores of the processing unit 150 use a relatively wide single instruction multiple data (SIMD) microarchitecture. Other types of data processing and a corresponding microarchitecture are also possible and contemplated.

It is noted that the computing system 100 can simultaneously include a heterogeneous computing architecture (or a heterogeneous processing architecture) and a heterogeneous architecture. For example, in various implementations, the computing system 100 includes the high-performance CPU core 112 and the low-power CPU core 116 that are architecturally compatible, but the throughput and the power consumption greatly differ between them. The computing system 100 also includes one or more cores of the processing unit 150 that use a different microarchitecture than a general-purpose CPU microarchitecture. One example of the different microarchitecture is the wide SIMD microarchitecture.

As described earlier, hardware, such as circuitry, of a particular core of the multiple cores executes instructions of an operating system scheduler at a current point in time, and this particular scheduling core assigns a thread to the high-performance core 112. The scheduling core assigns the thread to the high-performance core 112 based on availability of the multiple cores in the computing system 100, a round-robin scheduling scheme, or another initial scheduling scheme. It is possible and contemplated that other cores of the multiple cores include hardware that execute instructions of the operating system scheduler at other points in time. The high-performance core 112 determines a classification of the thread based on hardware performance metrics measured over a time interval. In various implementations, the high-performance core 112 includes hardware performance counters that monitor hardware events that occur in the high-performance core 112 while the first core executes the assigned thread. In some implementations, the high-performance core 112 includes one or more multi-bit registers that are used as hardware performance counters capable of counting multiple hardware-related activities.

Alternatively, the counters count the number of clock cycles that the high-performance core 112 spent performing predetermined events. Examples of events include pipeline flushes, data cache snoops and snoop hits, cache and translation lookaside buffer (TLB) misses, read and write operations, data cache lines written back, branch operations, taken branch operations, the number of instructions in an integer or floating-point pipeline, and bus utilization. Several other events are also possible and contemplated. In addition to storing absolute numbers corresponding to hardware-related activities, the counters of the high-performance core 112 determine and store relative numbers, such as a percentage of cache read operations that hit in a cache. In addition to the hardware performance counters, in an implementation, the high-performance core 112 includes a timestamp counter that is used to determine a time rate, or frequency, of hardware-related activities. For example, the first core uses the timestamp counter to store, and update a number of cache read operations per second, a number of pipeline flushes per second, a number of floating-point operations per second, or other. In various implementations, the low-power core 116 also includes one or more of these types of registers used to implement hardware performance counters.

The high-performance core 112 compares the values stored in one or more of the hardware performance counters to thresholds to determine the dynamic behavior of the assigned thread. The number of events that at least reach predetermined thresholds are used to determine the classification of the assigned thread. Examples of the classification are a non-scalable thread, an input/output (I/O) or memory bound thread, a vector thread, or other. The high-performance core 112 communicates the classification, which is an indication of thread dynamic behavior of the thread, with the scheduling core. In an implementation, the high-performance core 112 writes the indication in a predetermined configuration register that is later read by the scheduling core.

The scheduling core is capable of removing the thread from the high-performance core 112 and reassigning the thread to the low-power core 116 based at least in part on the indication of dynamic behavior of the thread. It is also noted that, in various implementations, one or more of the high-performance core 112 and the low-power core 116 includes hardware that is capable of executing multiple threads at a particular point in time due to supporting simultaneous multi-threading (SMT). If the high-performance core 112 supports SMT for four threads, then the scheduling core uses four separate logic processor identifiers (IDs) for assigning threads and reassigning threads. However, the scheduling core does not reassign a thread from a first logic processor ID of the high-performance core 112 to a second logic processor ID of the high-performance core 112 based on an indication of dynamic behavior of the thread.

In an implementation, the classification of the above thread indicates that the thread is part of a process that runs video playback, a process that runs input/output (I/O) bound or memory bound tasks, or a process that runs a pause or a spin loop (a busy spin or a wait spin). However, the scheduling core originally assigned the thread to the high-performance core 112 based on availability, a round-robin scheme, or other. These types of threads are preferably assigned to the low-power core 116. The high-performance core 112 communicates the classification (indication of dynamic thread behavior) to the scheduling core, and the scheduling core removes this thread from the high-performance core 112 and reassigns this thread to the low-power core 116.

In other implementations, the reassignment is from the low-power core 116 to the high-performance core 112. For example, when the scheduling core originally assigns threads of a real-time process, such as real-time audio/visual (A/V) processes of a video game, to the low-power core 116 based on availability, a round-robin scheme, or other, after a time interval, the low-power core 116 sends an indication of dynamic thread behavior to the scheduling core. Based on this indication, the scheduling core removes the real-time thread from the low-power core 116 and reassigns the real-time thread to the high-performance core 112. Before continuing with further details of efficiently scheduling tasks in a dynamic manner to multiple cores that support a heterogeneous computing architecture, a further description of the components of the computing system 100 is provided.

Interface 140 generally provides an interface for a variety of types of input/output (I/O) devices off the chip 110 to the shared cache memory subsystem 170 and processing units 115. Generally, interface logic 140 includes buffers for receiving packets from a corresponding link and for buffering packets to be transmitted upon a corresponding link. Any suitable flow control mechanism can be used for transmitting packets to and from the chip 110. The memory 130 can be used as system memory for the chip 110, and include any suitable memory devices such as one or more RAMBUS dynamic random access memories (DRAMs), synchronous DRAMs (SDRAMs), DRAM, static RAM, etc.

The address space of the chip 110 is divided among multiple memories corresponding to the multiple cores. In an implementation, the coherency point for an address is the memory controller 120, which communicates with the memory storing bytes corresponding to the address. Memory controller 120 includes control circuitry for interfacing to memories and request queues for queuing memory requests. Generally speaking, the communication fabric 160 responds to control packets received on the links of the IF 140, generates control packets in response to cores 112 and 116 and/or cache memory subsystems 114 and 118, generates probe commands and response packets in response to transactions selected by memory controller 120 for service, and to route packets to other nodes through interface logic 140. The communication fabric supports a variety of packet transmitting protocols and includes one or more of system buses, packet processing circuitry and packet selection arbitration logic, and queues for storing requests, responses and messages.

Cache memory subsystems 114 and 118 include relatively high-speed cache memories that store blocks of data. Cache memory subsystem 114 can be integrated within respective the high-performance core 112. Alternatively, cache memory subsystem 114 is connected to the high-performance core 112 in a backside cache configuration or an inline configuration, as desired. The cache memory subsystem 114 can be implemented as a hierarchy of caches. In an implementation, cache memory sub systems 114 represents a L2 cache structures, and shared cache subsystem 170 represents an L3 cache structure. The cache memory subsystem 118 can be implemented in any of the above manners described for the cache memory subsystem 114.

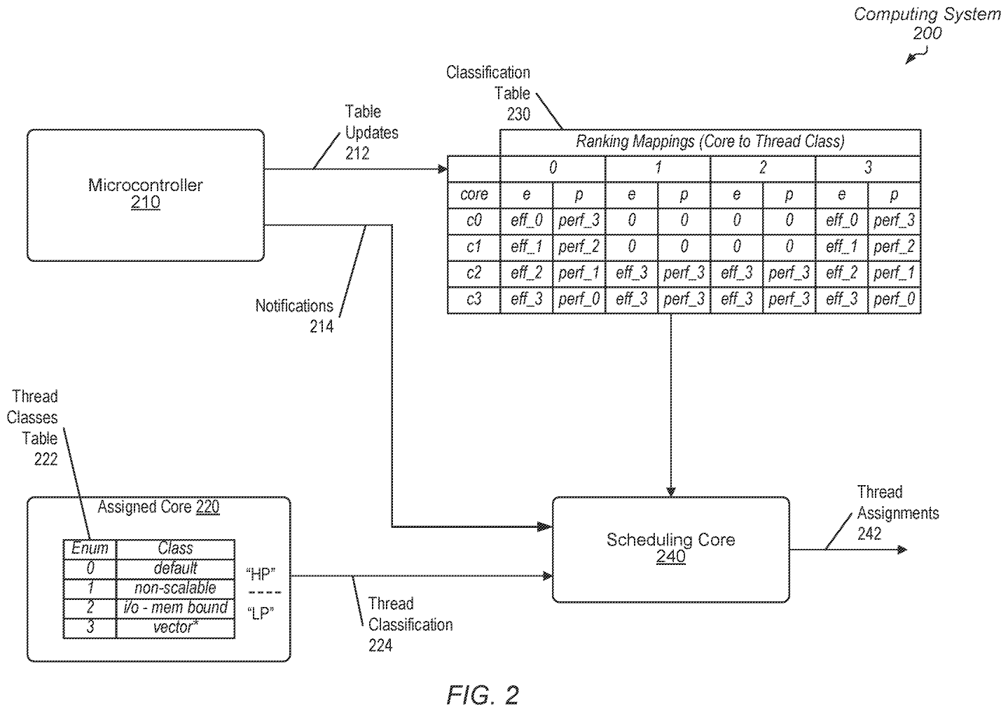

Turning now to FIG. 2, another generalized block diagram is shown of a computing system 200 that efficiently schedules threads on cores that support a heterogeneous computing architecture. The computing system 200 includes the microcontroller 210, the assigned processor core 220 (or core 220), the classification table 230, and the scheduler core 240. It is noted that while various references are made to a “table” or “tables” herein, in various implementations the data/content identified as being stored by such tables can be stored in any of a variety of forms other than a table, per se. For example, various data structures (tree, indexed, associate searched, etc.) allocated in a memory can be used to store the data. All such embodiments are possible and are contemplated. Clock sources, such as phase lock loops (PLLs), interrupt controllers, power controllers, interfaces for input/output (I/O) devices, and so forth are not shown in FIG. 2 for ease of illustration. In addition, in various implementations, the computing system 200 includes other cores in addition to the assigned core 220 and the scheduler core 240, and the computing system supports a multi-core heterogeneous computing architecture. In some implementations, the assigned core 220, the scheduler core 240, and other cores are general-purpose CPU cores. In another implementation, the functionality of the microcontroller 210 is implemented by a core or another integrated circuit.

The assigned core 220 includes a thread classes table 222 (or table 222) that maps a class identifier (ID) or enumerated value (Enum) to a particular thread class type. As shown, examples of the thread class types, or classifications, are a non-scalable thread, an input/output (I/O) or a memory bound thread, a vector thread, or other. A non-scalable thread is from a process that runs a pause or a spin loop (a busy spin or a wait spin), and in an implementation, a non-scalable thread is preferably assigned to a low-power core. In some implementations, a thread from a process that runs input/output (I/O) bound or memory bound tasks is also preferably assigned to a low-power core. A thread from a process that runs vector and/or floating-point operations is preferably assigned to a high-performance core. A thread that is not identified as being in any other class is identified as a default thread class type (or default classification). In an implementation, default threads are preferably assigned to a high-performance core. The “HP” indicator specifies that thread class types 0-1 are preferably assigned to a high-performance core, and the “LP” indicator specifies that thread class types 2-3 are preferably assigned to a low-power core. Other assignments and thread class types are possible and contemplated.

In an implementation, the microcontroller 210 executes instructions of firmware that implements an algorithm for generating and updating values stored in the classification table 230 (or table 230). The table 230 stores information that maps the cores of the computing system 200 that participate in the heterogeneous computing architecture to the identified thread class types. The mappings include rankings, which are weight values, that determine how strong is a preference for a particular thread class type to be assigned to a high-performance core or a low-power core. The cores are identified by a core identifier (ID), which are shown as “c0,” “c1,” and so on. The thread class types use the same identifiers as used in the table 222.

The ranking or weight for the mapping of the assignment between core “c0” and thread class type 0 is shown as “eff_0.” This ranking “eff_0” indicates that the thread class type 0 is not preferably assigned to a low-power core, but rather, a high-performance core. Here, the low-power cores are indicated as “e” and “eff” for efficient cores, and the high-performance cores are indicated as “p” and “perf” for performance cores. The ranking or weight for the mapping of the assignment between core “c0” and thread class type 0 is also shown as “perf_3.” Here, the higher the numerical value, the stronger the preference for the assignment. Therefore, this ranking “perf_3” indicates that the thread class type 0 is strongly preferred to be assigned to a high-performance core such as core “c0.” Here, a ranking or weight of “0” indicates a strong avoidance to making the corresponding assignment between core and thread class type. Other value types, ranges, and indications for the rankings in table 230 are possible and contemplated.

In some implementations, the hardware, such as circuitry, of the microcontroller 210, sends table updates 212 to a particular region of memory that stores the table 230. Copies of the tables 222 and 230 are stored in a variety of types of data storage areas. For example, copies of the data stored tables 222 and 230 are stored in one or more of registers, flip-flop circuits, one of a variety of random access memories, a content addressable memory (CAM), and so forth. A copy of the content of the tables 222 and 230 is also stored in non-volatile memory such as a hard disk, a solid-state drive, a read only memory (ROM), or other. When the microcontroller 210 generates, or later updates, the content stored in the table 230, the microcontroller 210 also sends a notification 214 to the scheduler core 240. In some implementations, the notification 214 is an interrupt sent from the microcontroller 210 to the scheduler core 240. When the scheduler core 240 receives the notification 214, the scheduler core 240 retrieves a most recent copy of the updated content, and updates its own local copy of the table 230.

The microcontroller 210 determines whether a system event has occurred in the computing system 200. Examples of the system event are detection of a notification of a throttling condition from a power manager due to a high thermal measurement above a threshold, a notification of a particular type of application being run such as a real-time audio/visual application, or other. If the microcontroller 210 determines a system event has occurred, then the microcontroller 210 updates the content in the table 230 and sends a notification 214 to the scheduler core 240.

The scheduler core 240 executes instructions of an operating system scheduler, and assigns a thread to the assigned core 220 based on availability, a round-robin scheme, or other. At this point in time, the scheduler core 240 is unaware of the dynamic thread behavior of the thread being assigned. In various implementations, the assigned core 220 includes hardware performance counters that monitor hardware events that occur in the assigned core 220 while the assigned core 220 executes the assigned thread. After a time interval elapses, the assigned core 220 compares the values stored in one or more of the hardware performance counters to thresholds to determine the dynamic behavior of the assigned threads. The assigned core 220 accesses the table 222 to perform the classification of the dynamic behavior of the assigned thread. The assigned core 220 reports the dynamic thread behavior to the scheduler core 240. In some implementations, the assigned core 220 writes a particular value (or values) indicating the thread classification 224 in a predetermined configuration register such as a machine-specific register (MSR) assigned to the assigned core 220. The scheduler core 240 periodically polls this configuration register and reads the stored value. The thread classification 224 provides scheduling feedback to the scheduler core 240. This scheduling feedback relies on the measured dynamic behavior of the thread running on the assigned core 220.

The scheduler core 240 accesses a copy of the table 230 with information regarding an identifier of the assigned core 220 and the received thread classification 224. In some implementations, the scheduler 240 first validates whether enough time has elapsed since assigning the thread to the assigned core 220 for accurate thread classification to occur. If so, then the scheduler core 240 accesses the copy of the table 230. If not, the scheduler core 240 sends an indication to the assigned core 220 to perform the classification again. Using the rankings (weights) in the table 230, the scheduler core 240 determines whether the thread should remain running on the assigned core 220. If not, then the scheduler core 240 identifies another core different from the assigned core 220 to run the thread. The scheduler core 240 sends the thread assignments 242 to the cores, which removes the thread from the assigned core 220 and assigns the thread to run on the identified different core.

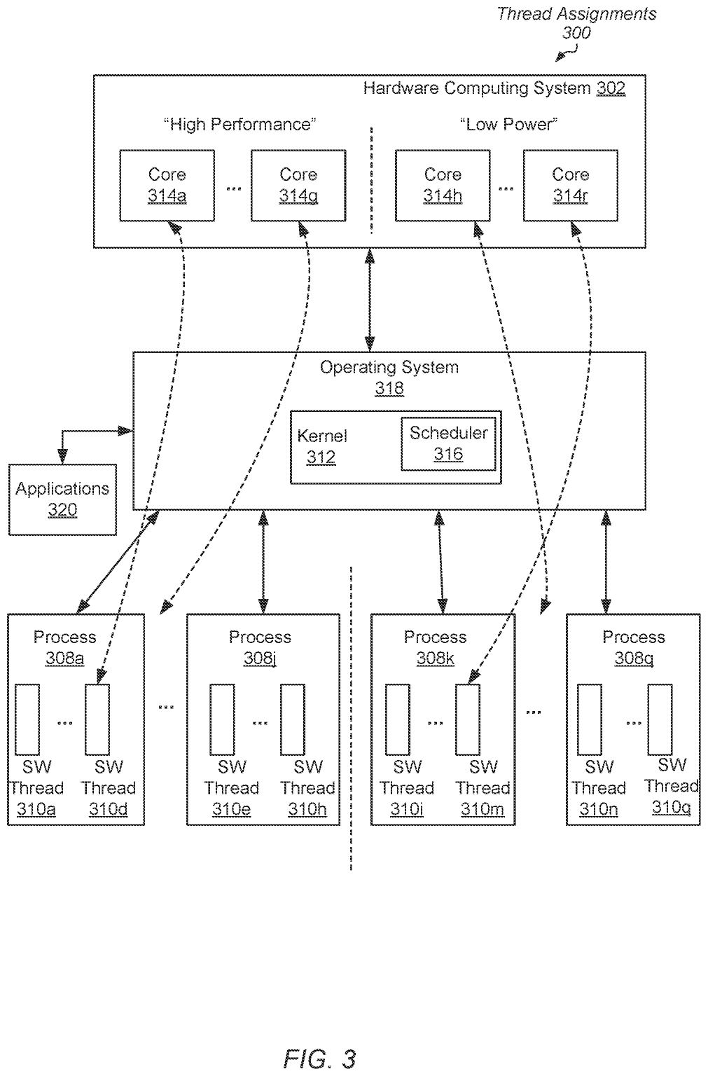

Referring to FIG. 3, a generalized block diagram is shown of thread assignments 300 for a computing system that uses cores that support a heterogeneous computing architecture. Here, the partitioning of hardware and software resources and their interrelationships and assignments during the execution of one or more software applications 320 is shown. In an implementation, circuitry of a scheduling core that executes the operating system 318 allocates regions of memory for processes 308a-308q. When applications 320, or computer programs, execute, each application includes multiple processes, such as Processes 308a-308j and 308k-308q. In such an implementation, each of the processes 308a-308q owns its own resources such as an image of memory, or an instance of instructions and data before application execution. Also, each of the processes 308a-308q includes process-specific information such as address space that addresses the code, data, and possibly a heap and a stack; variables in data and control registers such as stack pointers, general and floating-point registers, program counter, and otherwise; and operating system descriptors such as stdin, stdout, and otherwise, and security attributes such as processor owner and the process' set of permissions.

Within each of the of the processes 308a-308q, there are one or more software threads. For example, Process 308a comprises software (SW) Threads 310a-310d. A thread executes independent of other threads within its corresponding process and a thread can execute concurrently with other threads within its corresponding process. Generally speaking, each of the threads 310a-310q belongs to only one of the processes 308a-308q. Therefore, for multiple threads of the same process, such as SW Threads 310a-310d of Process 308a, the same data content of a memory line, for example the line of address 0xff38, can be the same for all threads. This assumes the inter-thread communication has been made secure and handles the conflict of a first thread, for example SW Thread 310a, writing a memory line that is read by a second thread, for example SW Thread 310d.

However, for multiple threads of different processes, such as SW Thread 310a in Process 308a and SW Thread 310e of Process 308j, the data content of memory line with address 0xff38 can be different for the threads. However, multiple threads of different processes can access the same data content at a particular address if they are sharing a same portion of address space. In general, for a given application, the scheduling core that executes the operating system 318 sets up an address space for an application, loads the application's code into memory, sets up a stack for the program, branches to a given location inside the application, and begins execution of the application. Typically, the portion of the operating system 318 that manages such activities is the operating system kernel 312.

As stated before, an application can be divided into more than one process and hardware computing system 302 can be running more than one application. Therefore, there can be several processes running in parallel. The scheduling core that executes the kernel 312 decides at any time which of the simultaneous executing processes should be allocated to the processor cores (or cores). A scheduler 316 in the operating system 318, which can be within kernel 312, includes decision logic for assigning threads of processes to cores. Also, the scheduling core that executes the scheduler 316 decides the assignment of a particular one of the software threads 310a-310q to a particular one of the hardware processor cores (or cores) 314a-314g and 314h-314r within the hardware computing system 302 as described further below.

In various implementations, the cores 314a-314g and 314h-314r are general-purpose CPU cores that include hardware that can handle the execution of the one or more threads 310a-310q within one of the processes 308a-308q. The hardware computing system 302 supports a heterogeneous computing architecture. A dashed line is used to separate high-performance cores 314a-314g from low-power cores 314h-314r. There are dashed lines in FIG. 3 that also denote assignments and do not necessarily denote direct physical connections. Thus, for example, SW Thread 310d can be assigned to high-performance core 314a. However, later (e.g., after a thread reassignment), a scheduling core removes SW Thread 310d from high-performance core 314a and reassigns SW Thread 310d to low-power core 314h based on an indication of dynamic behavior of the SW Thread 310d as reported by the high-performance core 314a.

In an implementation, an identifier (ID) is assigned to each of the cores 314a-314g and 314h-314r. This hardware thread ID (not shown) is used to assign one of the SW Threads 310a-310q to one of the cores 314a-314g for execution. The scheduling core that executes the scheduler 316 within kernel 312 handles this assignment. For example, the scheduling core uses a hardware thread ID to assign SW Thread 310m to low-power core 314r based on availability of the high-performance cores 314a-314g and the low-power cores 314h-314r, a round-robin scheduling scheme, or another initial scheduling scheme. The scheduling core that executes the scheduler 316 performs thread reassignment based on dynamic thread behavior reported by the high-performance cores 314a-314g and the low-power cores 314h-314r. For example, after a time interval of executing the SW Thread 310m, the low-power core 314r determines dynamic behavior of the SW Thread 310m. In an implementation, the low-power core 314r compares the values stored in one or more of the hardware performance counters to thresholds to determine the dynamic behavior of the SW Thread 310m. The low-power core 314r writes a particular value (or values) in a predetermined configuration register such as a machine-specific register (MSR) assigned to the low-power core 314r. In an implementation, the predetermined configuration register is a particular region of memory.

The scheduler checks, inspects, or polls this predetermined configuration register to determine the value stored in the predetermined configuration register. Based on the stored value that was written earlier by the low-power core 314r, the scheduler determines the classification, which is the indication of dynamic behavior of the thread as determined by the low-power core 314r. Based on this classification indicating the dynamic behavior of the SW Thread 310m as reported by the low-power core 314r, the scheduling core removes SW Thread 310m from low-power core 314r and reassigns SW Thread 310m to high-performance core 314g. To aid thread migration, user data allocated by one thread is used only by that thread and data sharing among threads occurs via read-only global variables and fast local message passing via the scheduling core that executes the thread scheduler 316. The scheduling core also handles any changes to stack pointers, if any.

In various implementations, the high-performance cores 314a-314g and the low-power cores 314h-314r include hardware performance counters that monitor hardware events that occur during a predetermined time interval while the high-performance cores 314a-314g and the low-power cores 314h-314r execute the assigned threads. After the time interval elapses, the high-performance cores 314a-314g and the low-power cores 314h-314r compare the values stored in one or more of the hardware performance counters to thresholds to determine the dynamic behavior of the assigned threads. The high-performance cores 314a-314g and the low-power cores 314h-314r report the dynamic thread behavior to the scheduling core, which determines whether to reassign the threads.

In an implementation, the scheduling core prefers to assign threads of a process that runs video playback, a process that runs input/output (I/O) bound or memory bound tasks, or a process that runs a pause or a spin loop (a busy spin or a wait spin) to the low-power cores 314h-314r. In contrast, the scheduling core prefers to assign threads of a real-time process, such a real-time A/V video game, to the high-performance cores 314a-314g. However, in some implementations, the preferences used by the scheduling core are programmable, and updated values of these preferences are stored in a table or other data storage area accessible by the scheduling core.

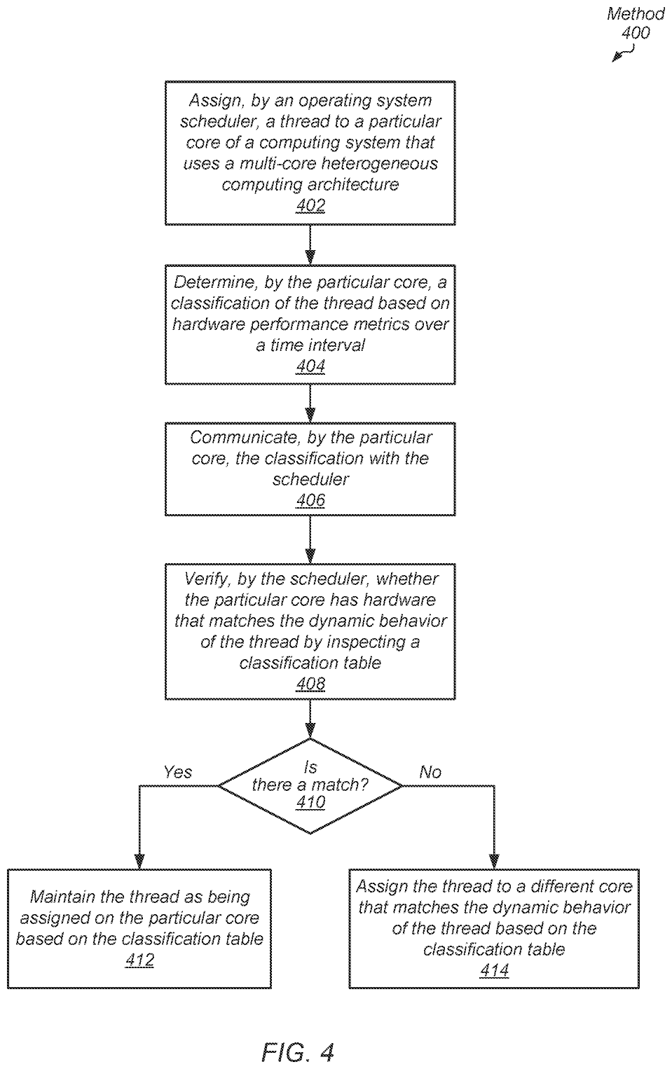

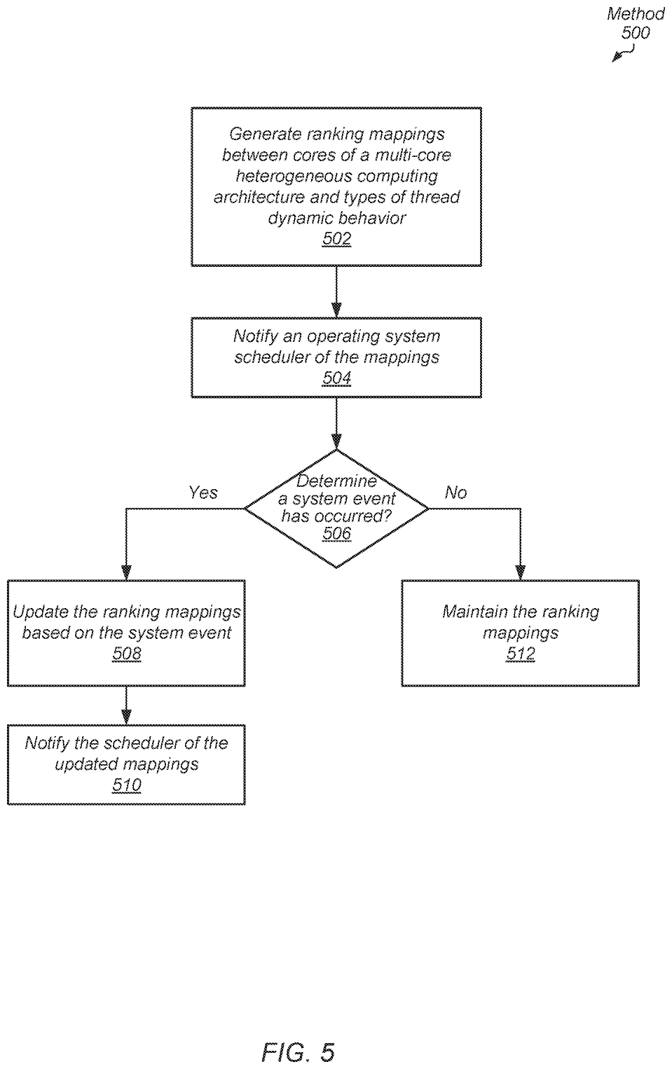

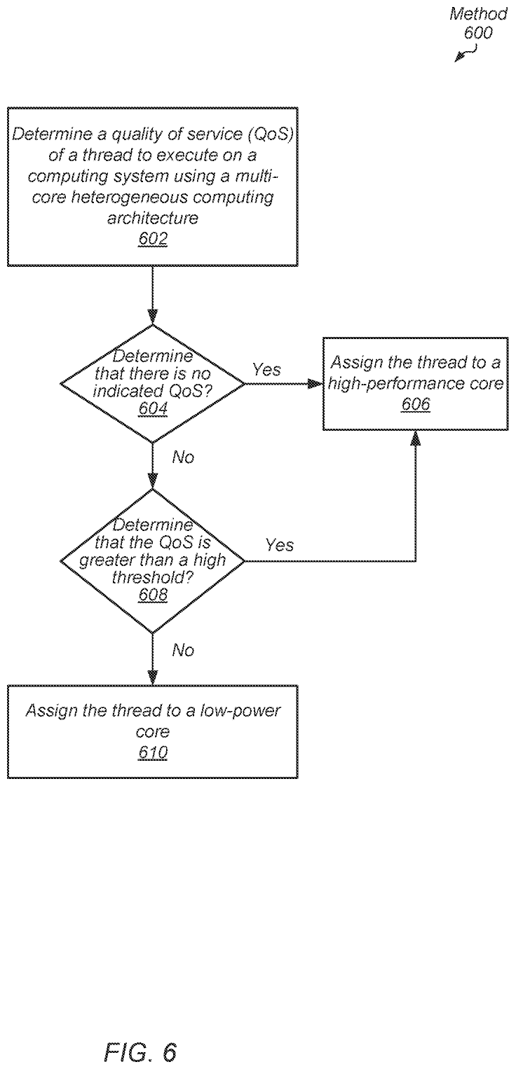

Turning now to FIG. 4, a generalized block diagram of a method 400 for assigning threads in a computing system that uses cores that support a heterogeneous computing architecture. For purposes of discussion, the steps in this implementation (as well as in FIGS. 5-6) are shown in sequential order. However, in other implementations some steps occur in a different order than shown, some steps are performed concurrently, some steps are combined with other steps, and some steps are absent.

A computing system includes multiple cores that support a heterogeneous computing architecture. Hardware of a certain general-purpose CPU processor core of the multiple cores executes instructions of an operating system scheduler, and this CPU processor core (or scheduler) assigns a thread to a particular processor core of multiple processor cores of a computing system (block 402). The scheduler assigns the thread to this particular processor core (or particular core) based on availability of the multiple cores, a round-robin scheduling scheme, or another initial scheduling scheme. This particular core determines a classification of the thread assigned to it based on hardware performance metrics measured over a time interval (block 404). In various implementations, the particular core includes hardware performance counters that monitor hardware events that occur in the particular core while the particular core executes the assigned thread. In some implementations, the particular core includes one or more multi-bit registers that are used as hardware performance counters capable of counting multiple hardware-related activities.

Alternatively, the counters count the number of clock cycles that the particular core spent performing predetermined events. Examples of events include pipeline flushes, data cache snoops and snoop hits, cache and TLB misses, read and write operations, data cache lines written back, branch operations, taken branch operations, the number of instructions in an integer or floating-point pipeline, and bus utilization. Several other events are also possible and contemplated. In addition to storing absolute numbers corresponding to hardware-related activities, the counters of the particular core determine and store relative numbers, such as a percentage of cache read operations that hit in a cache. In addition to the hardware performance counters, in an implementation, the particular core includes a timestamp counter that is used to determine a time rate, or frequency, of hardware-related activities. For example, the particular core uses the timestamp counter to store, and update a number of cache read operations per second, a number of pipeline flushes per second, a number of floating-point operations per second, or other.

The particular core compares the values stored in one or more of these hardware performance counters to thresholds to determine the dynamic behavior of the assigned thread. The number of events that at least reach predetermined thresholds are used to determine the classification of the assigned thread. Examples of the classification are a non-scalable thread, an input/output (I/O) or memory bound thread, a vector thread, or other. The particular core communicates the classification with the scheduler (block 406). In some implementations, the particular core writes a particular value (or values) in a predetermined configuration register such as a machine-specific register (MSR) assigned to the particular core. The scheduler verifies whether the particular core has hardware that matches the dynamic behavior of the thread by inspecting a classification table (block 408).

The classification table stores ranking mappings that indicate defined matches between the multiple cores and the multiple, predefined classifications of thread dynamic behavior. In some implementations, the classification table is generated and updated by another core of the multiple cores, a microcontroller, or other processing unit assigned to have its circuitry execute particular firmware with instructions of an algorithm that determines how and when to update the content of the classification table. The scheduler loads the contents of this classification table to a local cache, and accesses the classification table when evaluating an original thread assignment.

If the scheduler determines that there is a match between the assigned thread and the particular core based on the classification table (“yes” branch of the conditional block 410), then the scheduler maintains the thread as being assigned on the particular core (block 412). The match indicates the original thread assignment is found as a valid assignment in the classification table. If the scheduler determines that there is not a match based on the classification table (“no” branch of the conditional block 410), then the scheduler assigns the thread to a different core that matches the dynamic behavior of the thread based on the classification table (block 414). The different core is not the particular core, but another core of the multiple cores of the computing system that uses a multi-core heterogeneous computing architecture. The scheduler reassigns the thread from the particular core to the different core. It is noted that it is possible and contemplated that the scheduler includes other decision-making logic of a particular scheduling policy in addition to the steps performed in blocks 408-414 of method 400.

Referring to FIG. 5, a generalized block diagram of a method 500 for updating information used in assigning threads in a computing system that uses cores that support a heterogeneous computing architecture. A computing system includes multiple cores that support a heterogeneous computing architecture. Hardware, such as circuitry, of a particular processor core (or core) of the multiple cores or a microcontroller used in the computing system generates ranking mappings between the multiple cores and types of thread dynamic behavior (block 502). These ranking mapping are stored in a classification table. The circuitry notifies an operating system scheduler of the mappings (block 504). In some implementations, the particular core sends an interrupt to another core that executes the operating system scheduler.

The circuitry determines whether a system event has occurred. Examples of the system event are detection of a notification of a throttling condition from a power manager due to a high thermal measurement above a threshold, a notification of a particular type of application being run, or other. If the circuitry determines a system event has occurred (“yes” branch of the conditional block 506), then the circuitry updates the ranking mappings in the classification table based on the system event (block 508). For example, the circuitry updates the ranking mappings to indicate assigning more threads, and possibly all threads, to low-power cores, rather than high-performance cores, of the computing system using the heterogeneous computing architecture. The circuitry notifies the scheduler of the updated mappings (block 510). If the circuitry determines a system event has not occurred (“no” branch of the conditional block 506), then the circuitry maintains the ranking mappings in the classification table (block 512).

Turning now to FIG. 6, a generalized block diagram of a method 600 for assigning threads in a computing system that uses cores that support a heterogeneous computing architecture. A computing system includes multiple cores that support a heterogeneous computing architecture. Hardware, such as circuitry, of a particular processor core (or core) of the multiple cores determines a quality of service (QoS) of a thread (block 602). In some implementations, the particular core that determines the QoS value of a thread is the core that executes instructions of an operating system kernel. In other implementations, the threads (or processes) include an indication of a QoS value. If the particular core determines that there is no indication of a QoS value (“yes” branch of the conditional block 604), then the particular core assigns the thread to a high-performance core (block 606). In some implementations, each thread has a QoS value, and the conditional block 604 is unnecessary. In other implementations, a check is performed to determine whether a thread has an assigned QoS value as performed in the conditional block 604.

If the particular core determines that there is an indication of a QoS value (“no” branch of the conditional block 604), and the indicated QoS value is greater than a threshold (“yes” branch of the conditional block 608), then the particular core assigns the thread to a high-performance core (block 606). However, if the particular core determines that the indicated QoS value is less than or equal to the threshold (“no” branch of the conditional block 608), then the particular core assigns the thread to a low-power core (block 610). It is noted that these assignments can be switched with respect to the results of the comparison with the threshold in another implementation. It is also noted that the particular core can combine the results of assignment steps of method 600 with the assignment steps of methods 400-500 (of FIGS. 4-5). In yet other implementations, the particular core calculates a weighted score based on one or more of the results of assignment steps of method 600 and the assignment steps of methods 400-500 (of FIGS. 4-5). For example, a scheduler uses the QoS value in addition to the weights and the classification indicating the dynamic behavior of the thread when reassigning the thread from an originally assigned core to another core. A variety of combinations and methods are possible and contemplated for determining a final assignment of threads based on dynamic thread behavior in a heterogenous computing architecture.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a scheduler configured to:
receive an indication of thread dynamic behavior of a given thread assigned to a first core of a plurality of cores; and
reassign the given thread to a second core different from the first core of the plurality of cores based at least in part on the indication of thread dynamic behavior of the given thread.

2. The apparatus as recited in claim 1, wherein the scheduler is further configured to inspect ranking mappings that indicate defined matches between the plurality of cores and a plurality of classifications of thread dynamic behavior.

3. The apparatus as recited in claim 2, wherein the scheduler is further configured to reassign the given thread from the first core to the second core, in response to determining that the ranking mappings indicate the second core has a defined match with the indication of thread dynamic behavior.

4. The apparatus as recited in claim 2, wherein the scheduler is further configured to receive a notification that indicates that the ranking mappings have been updated.

5. The apparatus as recited in claim 1, wherein the scheduler is further configured to execute an operating system scheduler of a computing system using a multi-core heterogeneous computing architecture.

6. The apparatus as recited in claim 5, wherein:
the first core executes threads with a first microarchitecture; and
the second core executes threads with a second microarchitecture different from the first microarchitecture.

7. The apparatus as recited in claim 1, wherein the indication of thread dynamic behavior is based on hardware performance counters in the first core.

8. A method, comprising:
executing one or more applications by a plurality of cores;
receiving, by a given core, an indication of thread dynamic behavior of a given thread of the one or more applications assigned to a first core of the plurality of cores; and
reassigning, by the given core, the given thread to a second core different from the first core of the plurality of cores based at least in part on the indication of thread dynamic behavior of the given thread.

9. The method as recited in claim 8, further comprising inspecting, by the given core, ranking mappings that indicate defined matches between the plurality of cores and a plurality of classifications of thread dynamic behavior.

10. The method as recited in claim 9, further comprising reassigning, by the given core, the given thread from the first core to the second core, in response to determining that a ranking mapping indicates the second core has a defined match with the indication of thread dynamic behavior.

11. The method as recited in claim 9, further comprising receiving, by the given core, a notification that indicates that a ranking mapping has been updated.

12. The method as recited in claim 8, further comprising executing, by the given core, an operating system scheduler of a computing system using a multi-core heterogeneous computing architecture.

13. The method as recited in claim 12, further comprising:
executing threads by the first core with a first microarchitecture; and
executing threads by the second core with a second microarchitecture different from the first microarchitecture.

14. The method as recited in claim 8, wherein the indication of thread dynamic behavior is based on hardware performance counters in the first core.

15. A computing system comprising:
a memory configured to store one or more applications of a workload; and
a plurality of cores configured to execute the one or more applications; and
wherein a given core of the plurality of cores is configured to:
receive an indication of thread dynamic behavior of a given thread assigned to a first core of the plurality of cores; and
reassign the given thread to a second core different from the first core of the plurality of cores based at least in part on the indication of thread dynamic behavior of the given thread.

16. The computing system as recited in claim 15, wherein the given core is further configured to inspect ranking mappings that indicate defined matches between the plurality of cores and a plurality of classifications of thread dynamic behavior.

17. The computing system as recited in claim 16, wherein the given core is further configured to reassign the given thread from the first core to the second core, in response to determining that the ranking mappings indicate the second core has a defined match with the indication of thread dynamic behavior.

18. The computing system as recited in claim 16, wherein the given core is further configured to receive a notification that indicates that the ranking mappings have been updated.

19. The computing system as recited in claim 15, wherein the given core is further configured to execute an operating system scheduler of a computing system using a multi-core heterogeneous computing architecture.

20. The computing system as recited in claim 19, wherein:
the first core executes threads with a first microarchitecture; and
the second core executes threads with a second microarchitecture different from the first microarchitecture.
